(19) United States
(12) Patent Application Publication
(10) Pub. No.: US 2024/0400850 A1
(43) Pub. Date: Dec. 5, 2024

(54) LEAD COMPRISING BINDER MADE FROM CELLULOSE ESTERS

(71) Applicant: SOCIÉTÉ BIC, Clichy Cedex (FR)

(72) Inventors: Julien GOUEREC, Clichy Cedex (FR); Justine NAPOLY, Clichy Cedex (FR)

(73) Assignee: SOCIÉTÉ BIC, Clichy Cedex (FR)

(21) Appl. No.: 18/699,526

(22) PCT Filed: Oct. 25, 2022
(86) PCT No.: PCT/EP2022/079697

§ 371 Date: Apr. 8, 2024

(30) Foreign Application Priority Data
Oct. 26, 2021 (EP) 21306487.6

(51) Int. Cl. C09D 13/00; B43K 19/02; B43K 19/18; C08K 3/34; C08K 5/00; C08L 1/12; C08L 1/14

(52) U.S. Cl. CPC C09D 13/00; B43K 19/02; B43K 19/18; C08K 3/346; C08K 5/0041; C08L 1/12; C08L 1/14; C08K 2201/005

(57) ABSTRACT

The present disclosure relates to a writing instrument comprising a lead comprising a binder, a filler and a coloring agent, wherein the binder comprises a cellulose ester, wherein said cellulose ester comprises one or more acetate moieties and one or more ester moieties selected from C3-carboxylates, more specifically from propionate moieties.

This is a National Stage application under 35 U.S.C. § 371 of International Application No. PCT/EP2022/079697, filed Oct. 25, 2022, now published as WO 2023/072892 A1, which claims priority to European Patent Application No. 21306487.6, filed Oct. 26, 2021, the entireties of which are incorporated herein by reference.

### TECHNICAL FIELD

The present disclosure relates to the field of writing instruments. More specifically, the present disclosure relates to writing instruments, comprising leads comprising cellulose esters.

### BACKGROUND

Pencils are writing instruments which commonly comprise a lead placed in a casing. The pencils may be used to create marks by moving it across a writing surface. The physical abrasion between the lead and the writing surface may lead to a deposit of the lead's material which adheres to the writing surface creating a mark.

Conventional pencil leads, in particular graphite pencil leads, are commonly manufactured from finely ground graphite and clay powders. The mixture of the component is shaped into the desired lead shape. The preformed lead is then fired to harden the lead.

Traditional colored pencil leads typically comprise coloring agents, such as dyes or pigments, instead of graphite. The coloring agents are usually mixed with polymeric binders to form a lead. Traditional colored pencil leads are generally not calcinated. Indeed, the polymeric binders, commonly do not require a firing step to harden the lead, but rather at least one drying step in a drying chamber.

Synthetic colored pencil leads typically comprise coloring agents, such as dyes or pigments, instead of graphite. The coloring agents are usually mixed with polymeric binders, such as acrylonitrile-butadiene-styrene-copolymer (ABS), to form a lead. Unlike clay, the polymeric binders commonly do not require a firing step to harden the lead.

Polymeric binders such as ABS are based on petrochemicals. The production and disposal of polymeric binders based on petrochemicals may be detrimental to the environment. Further, the choice of binder is important in regard to the mechanical properties of the lead. One important property for colored pencil leads is their resistance to fracturing. However, increasing a colored pencil's resistance to fracturing is often accompanied by a reduction of deposit quality. The quality of deposit is important to performance, in particular the intensity (vividness) of the color deposited on a writing surface, e.g. paper.

The present disclosure aims to address one or more of the aforementioned issues in optimizing the lead.

### SUMMARY

In a first aspect, the present disclosure relates to a writing instrument comprising a lead comprising a binder, a filler and a coloring agent. The binder comprises a cellulose ester, wherein said cellulose ester comprises one or more acetate moieties and one or more ester moieties selected from C₃-carboxylates, more specifically from propionate moieties.

In some embodiments the cellulose ester may comprise one or more ester moieties selected from saturated C₃carboxylates, in particular moieties selected from propionate, more specifically n-propionate, iso-propionate; or mixtures thereof.

In some embodiments the cellulose ester may comprise cellulose acetate propionate.

In some embodiments the cellulose ester may comprise the acetate moieties and the one or more further ester moieties in a molar ratio of from about 10:1 to about 1:10, more specifically, between about 1:1 to about 1:4 and in particular between about 1:1.5 to about 1:3.

In some embodiments, the binder may further comprise a cellulose ester comprising one or more acetate moieties and one or more ester moieties selected from C₄-C₁₀-carboxylates, such as cellulose acetate butyrate.

In some embodiments, the cellulose ester may further comprise cellulose acetate butyrate.

In some embodiments the cellulose ester may comprise a number-average molecular weight of between about 15.000 g/mol to about 500.000 g/mol, more specifically between about 25.000 g/mol to about 400.000 g/mol and in particular between about 50.000 g/mol to about 200.000 g/mol.

In some embodiments the lead may comprise the binder in amounts of between about 5 and about 70 wt.-%, more specifically between about 7 and about 50 wt.-%, and in particular between about 10 and about 40 wt.-%, relative to the total weight of the lead.

In some embodiments the filler may comprise an inorganic filler, in particular a mineral filler.

In some embodiments the filler may comprise clay, talc, boron nitride, silica, calcium carbonate, mica, steatite powder and mixtures thereof.

In some embodiments the filler may comprise a clay selected from the group consisting of montmorillonite, bentonite, kaolin and mixtures thereof; and in particular kaolin.

In some embodiments the filler may exhibit a lamellar structure.

In some embodiments the filler may be colorless, white, or may have a CIELAB L* value of greater than about 70, more specifically greater than about 75, and in particular greater than about 80, measured according to ISO R457.

In some embodiments the filler may comprise particles having a particle size D50 by weight of between 1 and 5 μm, more specifically between 1 and 4 μm.

In some embodiments the lead may comprise the filler in amounts of between about 15 and about 75 wt.-%, more specifically between about 20 and about 65 wt.-%, and in particular between about 25 and about 55 wt.-%, relative to the total weight of the lead.

In some embodiments the coloring agent may comprise one or more pigments, one or more dyes, or mixtures thereof.

In some embodiments the coloring agent may comprise one or more pigments, more specifically one or more organic pigments.

In some embodiments the coloring agent may comprise azo pigments, diazo pigments, diarylide pigments pthalocyanines, dioxazines, quinacridones, iron oxides, pyrrole diones, titanium oxides, carbon black, graphites, ultramarine, benzimidazole and iron-cyan complexes.

In some embodiments the coloring agent may comprise Pigment Yellow 12, Pigment Yellow 110, Pigment Yellow 155, Pigment Yellow 180, Pigment Orange 13, Pigment Orange 36, Pigment Orange 64, Pigment Blue 15:1, Pigment Blue 15:3, Pigment Green 7, Pigment Green 36, Pigment Violet 19, Pigment Violet 23, Pigment Red 48:2, Pigment Red 57:1, Pigment Red 122, Pigment Red 170, Pigment Red 254, Pigment Red 266, Pigment Black 7, Pigment Black 6, Pigment Yellow 42, Pigment Red 101, Pigment White 6.

In some embodiments the lead may comprise the coloring agent in amounts of between about 2 and about 50 wt.-%, more specifically between about 5 and about 40 wt.-%, and in particular between about 10 and about 30 wt.-%, relative to the total weight of the lead.

In some embodiments the lead may further comprise one or more additives.

In some embodiments the one or more additives may be selected from the group consisting of slip agents, processing agents, coupling agents, dispersants, lubricants, plasticizers, preservatives, and mixtures thereof.

In some embodiments the one or more additives may be selected from the group consisting of
fatty acid salts;
fatty acids;
fatty acid esters;
plasticizers, in particular phthalate-based plasticizers; adipate-based plasticizers; benzoate-based plasticizers; sebacate-based plasticizers; citrate-based plasticizers;
amides, in particular as ethylene bis stearamide;
waxes;
glycerol and derivatives thereof, in particular glycerol behenate;
siloxanes;
   more specifically fatty acid salts, plasticizers, amides, glycerol and derivatives thereof.

In some embodiments the one or more additives may be selected from the group consisting of stearates such as calcium stearate, magnesium stearate, sodium stearate, zinc stearate and mixtures thereof; amides, in particular stearamides such as ethylene bis stearamide, waxes, fatty acids, glycerol and its derivatives such as glycerol behenate, glycerol dibehenate, glycerol stearate; and/or polyglycerol diisostearate, in particular glycerol behenate, siloxane grafted on polypropylene, maleic anhydride grafted polypropylene, phthalate, adipate, benzoate, sebacate; and/or citrate plasticizers and mixtures thereof; or from the group consisting of calcium stearate, ethylene bis stearamide, phthalates and mixtures thereof.

In some embodiments the lead may comprise the one or more additives in a total amount of between about 2 and about 35 wt.-%, more specifically between about 5 and about 30 wt.-%, and in particular between about 10 and about 25 wt.-%, relative to the total weight of the lead.

In some embodiments the lead may comprise, relative to the total weight of the lead, between about 0.5 and about 35 wt.-%, more specifically between about 1 and about 30 wt.-%, and in particular between about 1.4 and about 25 wt.-%, of one or more fatty acids, more specifically fatty acids comprising between about 8 and about 24 carbon atoms, in particular one or more fatty acids selected from caprylic acid, capric acid, lauric acid, myristic acid, palmitic acid, stearic acid.

In some embodiments the lead may comprise, relative to the total weight of the lead, between about 0.5 and about 35 wt.-%, more specifically between about 1 and about 30 wt.-%, and in particular between about 1.4 and about 25 wt.-%, of one or more fatty acid salts, more specifically fatty acid salts comprising between about 8 and about 24 carbon atoms, in particular salts selected from caprylate, caprate, laurate, myristate, palmitate and/or stearate salts.

In some embodiments the lead may comprise, relative to the total weight of the lead, between about 0.5 and about 35 wt.-%, more specifically between about 1 and about 30 wt.-%, and in particular between about 1.4 and about 25 wt.-%, of one or more fatty acid salts comprising an alkali metal and/or earth alkali metal, more specifically fatty acid salts comprising between about 8 and about 24 carbon atoms comprising sodium, calcium and/or magnesium, in particular calcium salts of one or more fatty acids selected from calcium caprylate, calcium caprate, calcium laurate, calcium myristate, calcium palmitate, calcium stearate.

In some embodiments the lead may comprise, relative to the total weight of the lead, between about 0.5 and about 15 wt.-%, more specifically between about 1 and about 7.0 wt.-%, and in particular between about 1.4 and about 5.0 wt.-%, of one or more fatty acid salts comprising a transition metal, more specifically fatty acid salts comprising between about 8 and about 24 carbon atoms comprising a transition metal, in particular zinc salts of one or more fatty acids selected from zinc caprylate, zinc caprate, zinc laurate, zinc myristate, zinc palmitate, zinc stearate.

In some embodiments the lead may comprise, relative to the total weight of the lead, between about 0.5 and about 15 wt.-%, more specifically between about 1 and about 10 wt.-%, and in particular between about 2 and about 8 wt.-%, of one or more plasticizers.

In some embodiments the one or more plasticizers may comprise a plasticizer selected from phthalate-based plasticizers, adipate-based plasticizers, benzoate-based plasticizers, sebacate-based plasticizers, and citrate-based plasticizers; and in particular a benzoate-based plasticizer.

In some embodiments the lead may exhibit a hexagonal, round or triangular cross section.

In some embodiments the lead may be extrudable, extruded or preparable by extrusion.

In some embodiments the lead may not be calcinable, not calcined or not preparable by calcination.

In some embodiments the lead may comprise less than about 10 wt.-%, more specifically less than about 5 wt.-% and in particular no or substantially no polyolefins or copolymers comprising olefine-based monomer units.

In some embodiments the lead may comprise less than about 10 wt.-%, more specifically less than about 5 wt.-% and in particular no or substantially no polystyrene or copolymers comprising styrene-based monomer units.

In some embodiments the lead may comprise less than about 10 wt.-%, more specifically less than about 5 wt.-% and in particular no or substantially no hydroxyalkyl cellulose and alkyl cellulose; and in particular no hydroxypropyl cellulose.

In some embodiments the lead may comprise less than about 10 wt.-%, more specifically less than about 5 wt.-% and in particular no or substantially no lactic acid-based polymer, in particular polylactic acid.

In some embodiments the lead may have a diameter of between about 2 and 4.2 mm, more specifically between about 2 and about 2.3 mm, or between about 3 and about 3.8 mm or between about 3.4 and about 3.8 mm.

In some embodiments the writing instrument may further comprise a casing enclosing the lead.

In some embodiments the casing may comprise wood or wood substitute, in particular wherein the wood substitute can comprise polyolefins or copolymers comprising olefine-based monomer units, polystyrene or copolymers comprising styrene-based monomer units, lactic acid-based polymer, in particular polylactic acid and mixtures thereof.

In some embodiments the casing may be co-extrudable or co-extruded with the lead.

In some embodiments the writing instrument may further comprise an intermediate layer between the lead and the casing, wherein the intermediate layer is configured to increase the adhesion between the lead and the casing.

In some embodiment the intermediate layer may comprise ethylene butylene acrylate, a mixture of ethylene butylene acrylate and cellulose, ethylene vinyl acetate and/or a mixture of ethylene vinyl acetate and cellulose.

In some embodiments the casing may be co-extrudable or co-extruded with the lead and the intermediate layer.

In a second aspect, the present disclosure related to a method of preparing a writing instrument comprising a lead comprising a binder, a filler and a coloring agent. The binder comprises a cellulose ester, wherein said cellulose ester comprises one or more acetate moieties and one or more further ester moieties selected from Cs-carboxylates, more specifically from propionate moieties. The method comprises combining the binder, the filler and the coloring agent. In some embodiments, the lead and the casing may be further characterized as disclosed for the first aspect of the present disclosure.

In some embodiments the lead may be prepared by extrusion.

In a third aspect, the present disclosure relates to a lead for a writing instrument comprising a lead comprising a binder, a filler and a coloring agent. The binder comprises a cellulose ester, wherein said cellulose ester comprises one or more acetate moieties and one or more ester moieties selected from C₃-carboxylates, more specifically from propionate moieties. In some embodiments, the lead may be further characterized as disclosed for the first aspect of the present disclosure.

In a fourth aspect, the present disclosure relates to the use of a binder comprising a cellulose ester, wherein said cellulose ester comprises one or more acetate moieties and one or more ester moieties selected from C₃-carboxylates for a lead of a writing instrument, to improve the intensity (vividness) of the color deposit and/or to improve the resistance to breakage of the lead.

In some embodiments, the cellulose ester comprises one or more acetate moieties and one or more ester moieties selected from saturated C₃-carboxylates, in particular moieties selected from propionate, more specifically n-propionate, iso-propionate or mixtures thereof.

In some embodiments, the cellulose ester comprises cellulose acetate propionate.

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

It has been surprisingly found that a binder comprising a cellulose ester, in particular a cellulose ester comprising one or more acetate moieties and one or more ester moieties selected from C₃-carboxylates, more specifically from propionate moieties, may be advantageously used in leads for writing instruments. The binder may be derived from renewable resources and/or may be biodegradable. The term “biodegradable” within this disclosure is not particularly limited and may in particular refer to a material property wherein the material decomposes by the action of microbes, in particular wherein the material decomposes into water, carbon dioxide, and biomass. The biodegradation may be able to take place in any environment comprising microbes or only in industrial composters. The biodegradation may convert 90% of the polymer to water, carbon dioxide and biomass within as time span of less than 10 years, more specifically less than 3 years and in particular within 6 months.

Furthermore, it has been surprisingly found that a binder comprising a cellulose ester comprising one or more acetate moieties and one or more ester moieties selected from C₃-carboxylates, more specifically from propionate moieties, may provide a lead with an improved resistance to breakage and color deposit. In particular, it has been found that deposits formed from leads comprising the binder comprising a cellulose ester one or more acetate moieties and one or more ester moieties selected from C₃-carboxylates, more specifically from propionate moieties, may exhibit a higher C*_{ab} value in the CIELCh color space (color saturation). A higher C*_{ab} values relates to an increased chroma. Within this disclosure the term “chroma” relates to its typical meaning in the art. In particular the term “chroma” may refer to colorfulness of an area judged as a proportion of the brightness of a similarly illuminated area that appears white or highly transmitting.

According to an advantageous embodiment of the disclosure, the lead according to the disclosure is a pencil lead, the resistance to breakage of which can be evaluated by a pencil flexural resistance measurement wherein a value of at least 0.4 daN, in particular of at least 0.6 daN is considered as acceptable for a lead with a diameter of at least 2 mm, more specifically at least 2.8 mm. A protocol for such measurement can be as mentioned in the examples section.

Accordingly, in a first aspect, the present disclosure relates to a writing instrument comprising a lead comprising a binder, a filler and a coloring agent. The binder comprises a cellulose ester, wherein said cellulose ester comprises one or more acetate moieties and one or more ester moieties selected from C₃-carboxylates, more specifically from propionate moieties.

Cellulose esters are cellulose derivatives wherein at least part of the cellulose's hydroxyl groups have reacted with a chemical reagent to form an ester bond. Many cellulose esters are renewable resources and/or biodegradable. The chemical reagent may for example comprise reactive acetate groups to form cellulose acetate or reactive propionate groups to form cellulose propionate. Cellulose may also be directly reacted with both a chemical reagent comprising a reactive acetate group and a reagent comprising a reactive propionate group, leading to a cellulose ester with two different substituents, referred to as cellulose acetate propionate.

In some embodiments, the cellulose ester may comprise one or more ester moieties selected from saturated C₃-carboxylates in particular moieties selected from propionate, more specifically n-propionate, iso-propionate; or mixtures thereof.

In some embodiments, the cellulose ester may comprise cellulose acetate propionate. A binder comprising cellulose acetate propionate may provide a lead with a high resistance to breakage and good deposit, more specifically a deposit with good intensity (color saturation).

In some embodiments, the cellulose ester may comprise the acetate moieties and the one or more further ester moieties in a molar ratio of from about 10:1 to about 1:10, more specifically, between about 1:1 to about 1:4 and in particular between about 1:1.5 to about 1:3.

In some embodiments, the binder may further comprise a cellulose ester comprising one or more acetate moieties and one or more ester moieties selected from C₄-C₁₀-carboxylates, such as cellulose acetate butyrate.

In some embodiments, the cellulose ester may further comprise cellulose acetate butyrate.

Depending upon the amount of each reagent or the reaction conditions during the esterification reaction the degree of substitution may vary. Further, the ratio of the acetate reagent to the propionate reagent may influence the ratio of acetate to propionate substituents present in the final cellulose ester. The ratio of acetate to propionate substituents may influence the properties of the final cellulose ester. A higher ratio of propionate may increase the compatibility with plasticizers or lubricants.

In some embodiments, the cellulose ester may comprise a number-average molecular weight of between about 15.000 g/mol to about 500.000 g/mol, more specifically between about 25.000 g/mol to about 400.000 g/mol and in particular between about 50.000 g/mol to about 200.000 g/mol. An increased number-average molecular weight may increase the mechanical properties of the cellulose ester. However, an increased number-average molecular weight may also increase the viscosity in its molten state, which may be undesirable during processing.

In some embodiments, the lead may comprise the binder in amounts of between about 5 wt.-% and about 70 wt.-%, more specifically between about 7 wt.-% and about 50 wt.-%, and in particular between about 10 wt.-% and about 40 wt.-%, relative to the total weight of the lead.

The term “binder” within this disclosure is not particularly limited and i.a. refers to its common meaning in the art. In particular, it may refer to an e.g. liquid or viscous substance that hardens by a chemical or physical process and binds by i.a. physically trapping or encasing or chemically joining other components, in this case in particular the filler and/or the coloring agent. A higher amount of binder may improve the mechanical properties of the lead but may reduce the chroma of the deposit.

In some embodiments, the filler may comprise an inorganic filler, in particular a mineral filler. The term “filler” within this disclosure is not particularly limited and i.a. refers to its common meaning in the art. In particular, it may refer to a particulate material added to the lead to increase its bulk, weight, viscosity, opacity and/or strength.

In some embodiments, the filler may comprise clay, talc, boron nitride, silica, calcium carbonate, mica, steatite powder and mixtures thereof.

In some embodiments, the filler may comprise a clay selected from the group consisting of montmorillonite, bentonite, kaolin and mixtures thereof; and in particular kaolin.

In some embodiments, the filler may exhibit a lamellar structure. In particular, clay, boron nitride, mica, talc and mixtures thereof may exhibit a lamellar structure. Fillers exhibiting a lamellar structure may increase the leads softness during writing, as the lamellar structure may break more easily during writing when in contact with a writing surface.

In some embodiments, the filler may be colorless, white, or may have a CIELAB L* value of greater than about 70, more specifically greater than about 75, and in particular greater than about 80, measured according to ISO R457. A higher CIELAB L* value may result in lighter colors and/or less alteration of the color provided by the pigments and/or dyes present in the lead.

In some embodiments, the filler may comprise particles having a particle size D50 by weight of between 1 and 5 μm, more specifically between 1 and 4 μm. The particle size D50 by weight may be measured by sedimentation for example using a SEDIGRAPH® III Plus 5125 apparatus from the company Micromeritics GmbH, Germany.

Fillers with a smaller particle size may lead to a more homogenous deposit. However, lower particle sizes may also tend to aggregate and hence be more difficult to use in manufacturing.

In some embodiments, the lead may comprise the filler in amounts of between about 15 and about 75 wt.-%, more specifically between about 20 and about 65 wt.-%, and in particular between about 25 and about 55 wt.-%, relative to the total weight of the lead.

The filler may improve the leads mechanical properties. The fillers may increase the leads resistance to breaking. Further, a higher amount of fillers may reduce the production cost of the lead, however, it may also lead to a reduction in chroma of the deposit.

In some embodiments, the coloring agent may comprise one or more pigments, one or more dyes, or mixtures thereof. The terms “pigment” and “dye” within this disclosure are not particularly limited and i.a. refers to its common meaning in the art. In particular “pigment” may refer that are completely or nearly insoluble in water, whereas “dye” may refer to soluble colorants.

The pigments and dyes may determine the color of the lead and/or of the deposit on the paper.

In some embodiments, the coloring agent may comprise one or more pigments, more specifically one or more organic pigments.

In some embodiments the coloring agent may comprise azo pigments, diazo pigments, diarylide pigments, pthalocyanines, dioxazines, quinacridones, iron oxides, pyrrole diones, titanium oxides, carbon black, graphites, ultramarine, benzimidazole and iron-cyan complexes.

In some embodiments, the coloring agent may comprise Pigment Yellow 12, Pigment Yellow 110, Pigment Yellow 155, Pigment Yellow 180, Pigment Orange 13, Pigment Orange 36, Pigment Orange 64, Pigment Blue 15:1, Pigment Blue 15:3, Pigment Green 7, Pigment Green 36, Pigment Violet 19, Pigment Violet 23, Pigment Red 48:2, Pigment Red 57:1, Pigment Red 122, Pigment Red 170, Pigment Red 254, Pigment Red 266, Pigment Black 7, Pigment Black 6, Pigment Yellow 42, Pigment Red 101, Pigment White 6.

In some embodiments, the lead may comprise the coloring agent in amounts of between about 2 and about 50 wt.-%, more specifically between about 5 and about 40 wt.-%, and in particular between about 10 and about 30 wt.-%, relative to the total weight of the lead.

A higher amount of coloring agents may lead to a deposit with a higher chroma. However, a higher amount of coloring agent may reduce the mechanical properties of the lead, in particular resistance to breaking and/or bending. Further, a higher amount of coloring agents may lead to higher material costs.

In some embodiments, the lead may further comprise one or more additives.

In some embodiments, the one or more additives may be selected from the group consisting of slip agents, processing agents, coupling agents, dispersants, lubricants, plasticizers, preservatives, and mixtures thereof.

In some embodiments, the one or more additives may be selected from the group consisting of
fatty acid salts;
fatty acids;
fatty acid esters;
plasticizers, in particular phthalate-based plasticizers; adipate-based plasticizers; benzoate-based plasticizers; sebacate-based plasticizers; citrate-based plasticizers;
amides, in particular as ethylene bis stearamide;
waxes;
glycerol and derivatives thereof, in particular glycerol behenate;
siloxanes;
   more specifically fatty acid salts, plasticizers, amides, glycerol and derivatives thereof.

The one or more additives may be selected from the group consisting of stearates such as calcium stearate, magnesium stearate, sodium stearate, zinc stearate and mixtures thereof; amides, in particular stearamides such as ethylene bis stearamide, waxes, fatty acids, glycerol and its derivatives such as glycerol behenate, glycerol dibehenate, glycerol stearate; and/or polyglycerol diisostearate, in particular glycerol behenate, siloxane grafted on polypropylene, maleic anhydride grafted polypropylene, phthalate, adipate, benzoate, sebacate; and/or citrate plasticizers and mixtures thereof; or from the group consisting of calcium stearate, ethylene bis stearamide, phthalates and mixtures thereof.

Stearates may be biodegradable and may act as lubricants during the writing action, which may protect the paper from excessive friction which could lead to damage. Moreover, stearates may have little influence on the color and quality of the deposit. Stearates may aid during manufacturing of the lead, in particular manufacturing by extrusion, e.g. by allowing the polymer-chains of the binder to slip past one another.

In some embodiments, the lead may comprise the one or more additives in a total amount of between about 2 and about 35 wt.-%, more specifically between about 5 and about 30 wt.-%, and in particular between about 10 and about 25 wt.-%, relative to the total weight of the lead.

In some embodiments, the lead may comprise, relative to the total weight of the lead, between about 0.5 and about 35 wt.-%, more specifically between about 1 and about 30 wt.-%, and in particular between about 1.4 and about 25 wt.-%, of one or more fatty acids, more specifically fatty acids comprising between about 8 and about 24 carbon atoms, in particular one or more fatty acids selected from caprylic acid, capric acid, lauric acid, myristic acid, palmitic acid, stearic acid.

In some embodiments, the lead may comprise, relative to the total weight of the lead, between about 0.5 and about 35 wt.-%, more specifically between about 1 and about 30 wt.-%, and in particular between about 1.4 and about 25 wt.-%, of one or more fatty acid salts, more specifically fatty acid salts comprising between about 8 and about 24 carbon atoms, in particular salts selected from caprylate, caprate, laurate, myristate, palmitate and/or stearate salts.

In some embodiments, the lead may comprise, relative to the total weight of the lead, between about 0.5 and about 35 wt.-%, more specifically between about 1 and about 30 wt.-%, and in particular between about 1.4 and about 25 wt.-%, of one or more fatty acid salts comprising an alkali metal and/or earth alkali metal, more specifically fatty acid salts comprising between about 8 and about 24 carbon atoms comprising sodium, calcium and/or magnesium, in particular calcium salts of one or more fatty acids selected from calcium caprylate, calcium caprate, calcium laurate, calcium myristate, calcium palmitate, calcium stearate.

The fatty acids and fatty acid salts comprising an alkali metal and/or earth alkali metal may be biodegradable. Further, the fatty acids and fatty acid salts comprising an alkali metal and/or earth alkali metal may act as lubricants during the writing action, which may protect the paper from excessive friction.

Moreover, the fatty acids and fatty acid salts comprising an alkali metal and/or earth alkali metal may have little influence on the color and quality of the deposit.

In some embodiments, the lead may comprise, relative to the total weight of the lead, between about 0.5 and about 15 wt.-%, more specifically between about 1 and about 7.0 wt.-%, and in particular between about 1.4 and about 5.0 wt.-%, of one or more fatty acid salts comprising a transition metal, more specifically fatty acid salts comprising between about 8 and about 24 carbon atoms comprising a transition metal, in particular zinc salts of one or more fatty acids selected from zinc caprylate, zinc caprate, zinc laurate, zinc myristate, zinc palmitate, zinc stearate.

Fatty acid salts comprising a transition metal may act as lubricants during production and may aid for example, in removing leads from molds. In particular zinc stearate may be a preferable lubricant during production. Further, fatty acid salts comprising a transition metal may be advantageous during manufacturing by extrusion, in particular by allowing the polymer-chains of the binder to slip past one another.

In some embodiments, the lead may comprise, relative to the total weight of the lead, between about 0.5 and about 15 wt.-%, more specifically between about 1 and about 10 wt.-%, and in particular between about 2 and about 8 wt.-%, of one or more plasticizers.

The term “plasticizer” within this disclosure is not particularly limited and i.a. refers to its common meaning in the art, e.g. as established in Jan W. Gooch (ed.), Encyclopedic Dictionary of Polymers, 2007, page 727, entry “Plasticizer”. Alternatively or additionally, the term “plasticizer” may refer to a substance, which reacts physically with the lead's components, in particular its polymeric components, to increase its flexibility, elongatibility and/or workability.

In some embodiments, the one or more plasticizers may comprise a plasticizer selected from phthalate-based plasticizers, adipate-based plasticizers, benzoate-based plasticizers, sebacate-based plasticizers, and citrate-based plasticizers; and in particular a benzoate-based plasticizer and/or an adipate-based plasticizer, such as bis(2-ethyl-hexyl adipate).

Plasticizers may reduce the hardness of the lead, which may reduce the required abrasion for creating the deposit and increase the leads flexibility. However, a high amount of plasticizers may also reduce the leads resistance to breakage and/or bending.

In some embodiments, the lead may be extrudable, extruded or preparable by extrusion.

In some embodiments the lead may not be calcinable, not calcined or not preparable by calcination. The term “calcination” within this disclosure is not particularly limited and i.a. refers to its common meaning in the art, e.g. as established in Jan W. Gooch (ed.), Encyclopedic Dictionary of Polymers, 2007, page 147, entry “Calcination”. In particular, the term “calcination” refers to processes wherein solid chemical compounds, such as clay, are heated to high temperatures (e.g. at least about 200° C.).

An extrudable lead may be more efficient to manufacture, compared to a calcinable lead. In particular, the extrusion may save time and energy during manufacturing compared to calcining. Further, during calcination the pigment and/or dyes may be damaged by the high temperatures, leading to a deposit with less chroma and/or altered colors.

In some embodiments, the lead may comprise less than about 10 wt.-%, more specifically less than about 5 wt.-% and in particular no or substantially no polyolefins or copolymers comprising olefine-based monomer units. Polymers comprising polyolefins or copolymers comprising olefine-based monomer units may not be biodegradable.

In some embodiments, the lead may comprise less than about 10 wt.-%, more specifically less than about 5 wt.-% and in particular no or substantially no polystyrene or copolymers comprising styrene-based monomer units. Polymers comprising polystyrene or copolymers comprising styrene-based monomer units may not be biodegradable.

In some embodiments, the lead may comprise less than about 10 wt.-%, more specifically less than about 5 wt.-% and in particular no or substantially no hydroxyalkyl cellulose and alkyl cellulose; and in particular no hydroxypropyl cellulose.

In some embodiments, the lead may comprise less than about 10 wt.-%, more specifically less than about 5 wt.-% and in particular no or substantially no lactic acid-based polymer, in particular polylactic acid.

Leads comprising polyolefins, copolymers comprising olefine-based monomer units, polystyrene, copolymers comprising styrene-based monomer units, hydroxyalkyl cellulose, alkyl cellulose or lactic acid-based polymers may have a high hardness and abrasion resistance, which may damage the writing surface during use of the writing instrument.

In some embodiments the lead may have a diameter of between about 2 and 4.2 mm, more specifically between about 2 and about 2.3 mm (also called thin lead or refill), or between about 3 and about 3.8 mm (also called thick lead or refill) or between about 3.4 and about 3.8 mm (also called very thick lead or refill).

In some embodiments the writing instrument may further comprise a casing enclosing the lead, in particular in order to facilitate the use by the consumer. The casing may protect the lead from the heat of the users hands and the users hands from discoloration by the lead.

In some embodiments, the casing may comprise wood or wood substitute, in particular wherein the wood substitute can comprise polyolefins or copolymers comprising olefine-based monomer units, polystyrene or copolymers comprising styrene-based monomer units, lactic acid-based polymer, in particular polylactic acid and mixtures thereof.

In some embodiments, the lead may exhibit a hexagonal, round or triangular cross section.

In some embodiments, the casing may be co-extrudable or co-extruded with the lead.

In some embodiments, the casing may exhibit a hexagonal, round or triangular cross section.

In some embodiments, the writing instrument may further comprise an intermediate layer between the lead and the casing, wherein the intermediate layer is configured to increase the adhesion between the lead and the casing.

In some embodiments, the intermediate layer may comprise ethylene butylene acrylate, a mixture of ethylene butylene acrylate and cellulose, ethylene vinyl acetate and/or a mixture of ethylene vinyl acetate and cellulose.

In some embodiments, the casing may be co-extrudable or co-extruded with the lead and the intermediate layer.

Co-extruding different layers may improve the efficiency of the extrusion process, compared to extruding the layers in a sequential manner.

In a second aspect, the present disclosure related to a method of preparing a writing instrument comprising a lead comprising a binder, a filler and a coloring agent. The binder comprises a cellulose ester, wherein said cellulose ester comprises one or more acetate moieties and one or more further ester moieties selected from Cs-carboxylates, more specifically from propionate moieties. The method comprises combining the binder, the filler and the coloring agent.

In some embodiments the lead may be prepared by extrusion.

In a third aspect, the present disclosure relates to a lead for a writing instrument comprising a lead comprising a binder, a filler and a coloring agent. The binder comprises a cellulose ester, wherein said cellulose ester comprises one or more acetate moieties and one or more ester moieties selected from C₃-C₁₀-carboxylates, more specifically from propionate moieties.

In a fourth aspect, the present disclosure relates to the use of a binder comprising a cellulose ester, wherein said cellulose ester comprises one or more acetate moieties and one or more ester moieties selected from C₃-carboxylates for a lead of a writing instrument, to improve the intensity (vividness) of the color deposit and/or to improve the resistance to breakage of the lead.

In some embodiments, the cellulose ester comprises one or more acetate moieties and one or more ester moieties selected from saturated C₃carboxylates, in particular moieties selected from propionate, more specifically n-propionate, iso-propionate, or mixtures thereof.

In some embodiments, the cellulose ester comprises cellulose acetate propionate.

### Example A

A lead comprising a cellulose ester as binder, in particular cellulose acetate propionate, was prepared with a composition as shown in Example 1 of Table 1 by compounding. The lead according to Example 1 was then compared to a lead comprising ABS as a binder, as described in the Comparative Example 1 of Table 1.

TABLE 1
Composition of Example 1 and the
Comparative Example 1

| | Example 1 | Comparative |
|---|---|---|
| | Amount | Example 1 |
| Chemical name | in wt.-% | Amount in wt.-% |
| TR6021 Natural from | 20% | — |
| Eastman | | |
| ABS | — | 20% |
| Kaolin | 47% | 47% |
| Zn stearate | 3% | 3% |
| Benzoate ester | 5% | 5% |
| (Benzoflex ®) | | |
| Stearic acid | 10% | 10% |
| Organic pigment (PY180, | 15% | 15% |
| CAS Number: 77804-81-0) | | |

The pencil leads were produced by carrying out the steps detailed below:
1. Mixing and granulating all formulation components of the lead to form a writing substance granulate;
2. Extruding the writing substance granulate at a temperature in the range of 130 to 200° C. on an extruder by a suitable mouthpiece to form an endless writing substance strand. In particular, the leads are manufactured from the below compositions by extrusion of an endless writing substance strand using a laboratory single-screw extruder, with 3 zones heated at 170° C., and a round die having a diameter of 2 mm followed by a drawing bench;
3. Cooling the endless writing substance strand, whereby the writing substance strand solidifies;
4. Cutting the endless writing substance strand to final lengths, in particular to the required pencil length.

The properties of chroma (C*_{ab}) and Pencil Flexural resistance (Flexion (daN)) of the leads were measured as described in the following.

### Pencil Flexural Resistance:

The pencil flexural resistance test was carried out in order to check the resistance of the pencil lead, in particular the resistance to breakage, in particular a value of above 0.4 daN is considered as acceptable for a lead with a diameter of above 2 mm, in particular a value of 0.6 daN is considered as even more acceptable.

For testing a Digital Testing Machine-LF Plus Series-Lloyd Instruments, Ametek, Inc., Pennsylvania, USA, was used. The span of the U-bracket was 6 cm. Sensor ADAMEL DY20 Chatillon Instrument type TCD110 50 daN was used. The descent speed of the sensor was set to 50 mm/min.

The test for the pencil's flexural resistance was carried out by the following protocol:
1. Turn on the testing machine;
2. Locate the sensor in a top position;
3. Fix the pencil on the U-bracket;
4. Move the sensor downwards:
5. Record the results expressed in daN.

The diameter differences between the samples that may occur due to die swell are compensated by calculating the 3-point pencil flexural resistance, relative to a nominal value of 2.8 mm.

### Colorimetry:

As equipment a Writing apparatus HST 10 by the company HUTT Maschinenbau, Germany was used under the following conditions:
Writing speed: 4.5 m/min
Writing angle: 70°-Furthermore, the following equipment was used:
ISO paper: AURORA ISO-14145
Pencil sharpener
CM-3610 A Spectrophotometer, KONICA MINOLTA, Japan
   Viewing angle of light: 10°

TABLE 2

| | Parameters for producing the deposits |
|---|---|
| Article type | Lead (As specified in Table 1) |
| Diameter lead (mm) | 2 |
| Paper feed (mm/min) | 0.15 |
| Total weight article/support/ | 175 |
| additional weight (g) | |
| Writing length for axial | 9 |
| rotation of the article (m) | |
| Writing length (m) | 40 |
| Paper type | AURORA ISO-14145 |

The test for the deposit's chroma was carried out by the following protocol:
1. Place the writing article in the appropriate supports, sharpen the lead if necessary;
2. Produce a deposit according to the parameters specified in Table 2;
3. Measure the chroma of the deposit with the KONICA MINOLTA CM-3610 A spectrophotometer.

To determine the chroma of a lead's deposit in accordance with the disclosure, the measurement of colorimetry can be performed. The chroma can be measured by colorimetry test by measuring the color difference AC between a sample color's C*_{ab}-value and a comparative color's C*_{ab}-value.

The density of the color of the deposit has been measured in the CIEL*a*b* system using a KONICA MINOLTA CM-3610 A spectrophotometer (settings illuminant: D65, angle 10°, specular components included).

According to this system, L* indicates the lightness of the color of the deposit. The lower the value of L, the darker is the color of the deposit. L*=0 yields black and L*=100 indicates diffuse white.

The chromaticity coordinates are expressed by the parameters a and b*, a* indicating the axis of red/green shades and b* the axis of yellow/blue shades. The chroma C*_{ab} is obtained from the following formula:

$${C}_{a b}^{*} = \sqrt{{a}^{* 2} + {b}^{* 2}}$$

All colorimetric measurements have been performed on a deposit made on the white paper AURORA ISO-14145.

The greater the value of Cab, the better the chroma of the color of the deposit.

### Results of the Tests

The composition according to Example 1 had a Flexion of 1.1 daN. The composition according to the Comparative Example 1 had a Flexion of 0.8 daN. The C*_{ab} value of the Example 1 was 26.97 and the C*_{ab} value of the Comparative Example 1 was 24.91.

Thus, the lead of Example 1, which had a composition according to the disclosure, had a higher flexural modulus than the flexural modulus of Comparative Example 1. Further, the lead of Example 1 had a higher chroma.

### Example B

A lead comprising cellulose acetate propionate was prepared with a composition as shown in Example 2 of Table 3 by compounding. The lead according to Example 2 was then compared to a lead comprising cellulose acetate butyrate as a binder, as described in the Comparative Example 2 of Table 3. ROTUBA CAP CP 800 comprises about 12% of bis(2-ethyl-hexyl adipate) as a plasticizer and ROTUBA CAB CP 902 comprises about 11% of bis(2-ethyl-hexyl adipate) as a plasticizer.

TABLE 3
Composition of Example 2 and the
Comparative Example 2

| | Example 2 | Comparative |
|---|---|---|
| | Amount | Example 2 |
| Chemical name | in wt.-% | Amount in wt.-% |
| ROTUBA CAP CP 800 | 20% | — |
| ROTUBA CAB CP 902 | — | 20% |
| Kaolin | 52% | 52% |
| Zn stearate | 3% | 3% |
| Stearic acid | 10% | 10% |
| Organic pigment (PY180, | 15% | 15% |
| CAS Number: 77804-81-0) | | |

The pencil leads were produced by carrying out the steps detailed below:
1. Mixing and granulating all formulation components of the lead to form a writing substance granulate;
2. Extruding the writing substance granulate at a temperature in the range of 130 to 200° C. on an extruder by a suitable mouthpiece to form an endless writing substance strand. In particular, the leads are manufactured from the below compositions by extrusion of an endless writing substance strand using a laboratory single-screw extruder, with 3 zones heated at 170° C., and a round die having a diameter of 3 mm followed by a drawing bench;
3. Cooling the endless writing substance strand, whereby the writing substance strand solidifies;

Cutting the endless writing substance strand to final lengths, in particular to the required pencil length.

The properties of chroma (C*_{ab}) and Pencil Flexural resistance (Flexion (daN)) of the leads were measured as described in the following.

### Pencil Flexural Resistance:

The pencil flexural resistance test was carried out in order to check the resistance of the pencil lead, in particular the resistance to breakage, in particular a value of above 0.4 daN is considered as acceptable for a lead with a diameter of above 2 mm, in particular a value of 0.6 daN is considered as even more acceptable.

For testing a Digital Testing Machine-LF Plus Series-Lloyd Instruments, Ametek, Inc., Pennsylvania, USA, was used. The span of the U-bracket was 6 cm. Sensor ADAMEL DY20 Chatillon Instrument type TCD110 50 daN. The descent speed of the sensor was set to 50 mm/min.

The test for the pencil's flexural resistance was carried out by the following protocol:
Turn on the testing machine;
Locate the sensor in a top position;
Fix the pencil on the U-bracket;
Move the sensor downwards:
Record the results expressed in daN.

The diameter differences between the samples that may occur due to die swell are compensated by calculating the 3-point pencil flexural resistance, relative to a nominal value of 2.8 mm.

### Colorimetry:

As equipment a Writing apparatus HST 10 by the company HUTT Maschinenbau, Germany was used under the following conditions:
Writing speed: 4.5 m/min
Writing angle: 70°-Furthermore, the following equipment was used:
ISO paper: AURORA ISO-14145
Pencil sharpener
CM-3610 A Spectrophotometer, KONICA MINOLTA, Japan
Viewing angle of light: 10°

TABLE 4

| | Parameters for |
|---|---|
| | producing the deposits |
| Article type | Lead (As specified in Table 3) |
| Diameter lead (mm) | 3 |
| Paper feed (mm/min) | 0.15 |
| Total weight article/support/ | 175 |
| additional weight (g) | |
| Writing length for axial | 9 |
| rotation of the article (m) | |
| Writing length (m) | 40 |
| Paper type | AURORA ISO-14145 |

The test for the deposit's chroma was carried out by the following protocol:
1. Place the writing article in the appropriate supports, sharpen the lead if necessary;
2. Produce a deposit according to the parameters specified in Table 4;
3. Measure the chroma of the deposit with the KONICA MINOLTA CM-3610 A spectrophotometer.

To determine the chroma of a lead's deposit in accordance with the disclosure, the measurement of colorimetry can be performed. The chroma can be measured by colorimetry test by measuring the color difference AC between a sample color's C*_{ab}-value and a comparative color's C*_{ab}-value.

The density of the color of the deposit has been measured in the CIEL*a*b* system using a KONICA MINOLTA CM-3610 A spectrophotometer (settings illuminant: D65, angle 10°, specular components included).

According to this system, L* indicates the lightness of the color of the deposit. The lower the value of L, the darker is the color of the deposit. L*=0 yields black and L*=100 indicates diffuse white.

The chromaticity coordinates are expressed by the parameters a* and b*, a* indicating the axis of red/green shades and b* the axis of yellow/blue shades. The chroma C*_{ab} is obtained from the following formula:

$${C}_{a b}^{*} = \sqrt{{a}^{* 2} + {b}^{* 2}}$$

All colorimetric measurements have been performed on a deposit made on the white paper AURORA ISO-14145.

The greater the value of C*_{ab}, the better the chroma of the color of the deposit.

### Results of the Tests

The composition according to Example 2 had a Flexion of 0.7 daN. The composition according to the Comparative Example 2 had a Flexion of 0.8 daN.

The C*_{ab} value of the Example 2 was 30.46 and the C*_{ab} value of the Comparative example 2 was 26.39.

Thus, the lead of Example 2, which had a composition according to the disclosure, exhibits a flexural modulus close to the one of Comparative example 2 and that is of acceptable value. Further, the color deposit made with the lead composition of Example 2 exhibits a higher chroma, in other words a better color saturation, than that of the composition of the Comparative example 2.

### Aspects

1. A writing instrument comprising a lead comprising a binder, a filler and a coloring agent, wherein the binder comprises a cellulose ester, wherein said cellulose ester comprises one or more acetate moieties and one or more ester moieties selected from Cs-carboxylates, more specifically from propionate moieties.
2. The writing instrument according to any preceding aspect, wherein the cellulose ester comprises one or more ester moieties selected from saturated C₃-carboxylates, in particular moieties selected from propionate, more specifically n-propionate, iso-propionate, or mixtures thereof.
3. The writing instrument according to any preceding aspect, wherein the cellulose ester comprises cellulose acetate propionate.
4. The writing instrument according to aspect 3, wherein the cellulose ester comprises the acetate moieties and the one or more further ester moieties in a molar ratio of from about 10:1 to about 1:10, more specifically, between about 1:1 to about 1:4 and in particular between about 1:1.5 to about 1:3.
5. The writing instrument according to any preceding aspect, wherein the binder further comprises a cellulose ester comprising one or more acetate moieties and one or more ester moieties selected from C₄-C₁₀-carboxylates, such as cellulose acetate butyrate.
6. The writing instrument according to any preceding aspect, wherein the cellulose ester further comprises cellulose acetate butyrate.
7. The writing instrument according to any preceding aspect, wherein the cellulose ester comprises a number-average molecular weight of between about 15.000 g/mol to about 500.000 g/mol, more specifically between about 25.000 g/mol to about 400.000 g/mol and in particular between about 50.000 g/mol to about 200.000 g/mol.
8. The writing instrument according to any preceding aspect, wherein the lead comprises the binder in amounts of between about 5 and about 70 wt.-%, more specifically between about 7 and about 50 wt.-%, and in particular between about 10 and about 40 wt.-%, relative to the total weight of the lead.
9. The writing instrument according to any preceding aspect, wherein the filler comprises an inorganic filler, in particular a mineral filler.
10. The writing instrument according to any preceding aspect, wherein the filler comprises clay, talc, boron nitride, silica, calcium carbonate, mica, steatite powder and mixtures thereof.
11. The writing instrument according to any preceding aspect, wherein the filler comprises a clay selected from the group consisting of montmorillonite, bentonite, kaolin and mixtures thereof; and in particular kaolin.
12. The writing instrument according to any preceding aspect, wherein the filler exhibits a lamellar structure.
13. The writing instrument according to any preceding aspect, wherein the filler is colorless, white, or may have a CIELAB L* value of greater than about 70, more specifically greater than about 75, and in particular greater than about 80, measured according to ISO R457.
14. The writing instrument according to any preceding aspect, wherein the filler comprises particles having a particle size D50 by weight measured by sedimentation, for example, using a SEDIGRAPH® apparatus from the company Micromeritics, of between 1 and 5 μm, more specifically between 1 and 4 μm.
15. The writing instrument according to any preceding aspect, wherein the lead comprises the filler in amounts of between about 15 and about 75 wt.-%, more specifically between about 20 and about 65 wt.-%, and in particular between about 25 and about 55 wt.-%, relative to the total weight of the lead.
16. The writing instrument according to any preceding aspect, wherein the coloring agent comprises one or more pigments, one or more dyes, or mixtures thereof.
17. The writing instrument according to any preceding aspect, wherein the coloring agent comprises one or more pigments, more specifically one or more organic pigments.
18. The writing instrument according to any preceding aspect, wherein the coloring agent comprises azo pigments, diazo pigments, diarylide pigments pthalocyanines, dioxazines, quinacridones, iron oxides, pyrrole diones, titanium oxides, carbon black, graphites, ultramarine, benzimidazole and iron-cyan complexes.
19. The writing instrument according to any preceding aspect, wherein the coloring agent comprises Pigment Yellow 12, Pigment Yellow 110, Pigment Yellow 155, Pigment Yellow 180, Pigment Orange 13, Pigment Orange 36, Pigment Orange 64, Pigment Blue 15:1, Pigment Blue 15:3, Pigment Green 7, Pigment Green 36, Pigment Violet 19, Pigment Violet 23, Pigment Red 48:2, Pigment Red 57:1, Pigment Red 122, Pigment Red 170, Pigment Red 254, Pigment Red 266, Pigment Black 7, Pigment Black 6, Pigment Yellow 42, Pigment Red 101, Pigment White 6.
20. The writing instrument according to any preceding aspect, wherein the lead comprises the coloring agent in amounts of between about 2 and about 50 wt.-%, more specifically between about 5 and about 40 wt.-%, and in particular between about 10 and about 30 wt.-%, relative to the total weight of the lead.
21. The writing instrument according to any preceding aspect, wherein the lead further comprises one or more additives.
22. The writing instrument according to aspect 21, wherein the one or more additives is selected from the group consisting of slip agents, processing agents, coupling agents, dispersants, lubricants, plasticizers, preservatives and mixtures thereof.
23. The writing instrument according to aspects 21 or 22, wherein the one or more additives is selected from the group consisting of
   fatty acid salts;
   fatty acids;
   fatty acid esters;
   plasticizers, in particular phthalate-based plasticizers; adipate-based plasticizers; benzoate-based plasticizers; sebacate-based plasticizers; citrate-based plasticizers;
   amides, in particular as ethylene bis stearamide;
   waxes;
   glycerol and derivatives thereof, in particular glycerol behenate;
   siloxanes;
   more specifically fatty acid salts, plasticizers, amides, glycerol and derivatives thereof.
24. The writing instrument according to any one aspects 21 to 23, wherein the one or more additives is selected from the group consisting of stearates such as calcium stearate, magnesium stearate, sodium stearate, zinc stearate and mixtures thereof; amides, in particular stearamides such as ethylene bis stearamide, waxes, fatty acids, glycerol and its derivatives such as glycerol behenate, glycerol dibehenate, glycerol stearate; and/or polyglycerol diisostearate, in particular glycerol behenate, siloxane grafted on polypropylene, maleic anhydride grafted polypropylene, phthalate, adipate, benzoate, sebacate; and/or citrate plasticizers and mixtures thereof; or from the group consisting of calcium stearate, ethylene bis stearamide, phthalates and mixtures thereof.
25. The writing instrument according to any one of aspects 21 to 24, wherein the lead comprises the one or more additives in a total amount of between about 2 and about 35 wt.-%, more specifically between about 5 and about 30 wt.-%, and in particular between about 10 and about 25 wt.-%, relative to the total weight of the lead.
26. The writing instrument according to any preceding aspect, wherein the lead comprises, relative to the total weight of the lead, between about 0.5 and about 35 wt.-%, more specifically between about 1 and about 30 wt.-%, and in particular between about 1.4 and about 25 wt.-%, of one or more fatty acids, more specifically fatty acids comprising between about 8 and about 24 carbon atoms, in particular one or more fatty acids selected from caprylic acid, capric acid, lauric acid, myristic acid, palmitic acid, stearic acid.
27. The writing instrument according to any preceding aspect, wherein the lead comprises, relative to the total weight of the lead, between about 0.5 and about 35 wt.-%, more specifically between about 1 and about 30 wt.-%, and in particular between about 1.4 and about 25 wt.-%, of one or more fatty acid salts, more specifically fatty acid salts comprising between about 8 and about 24 carbon atoms, in particular salts selected from caprylate, caprate, laurate, myristate, palmitate and/or stearate salts.
28. The writing instrument according to any preceding aspect, wherein the lead comprises, relative to the total weight of the lead, between about 0.5 and about 35 wt.-%, more specifically between about 1 and about 30 wt.-%, and in particular between about 1.4 and about 25 wt.-%, of one or more fatty acid salts comprising an alkali metal and/or earth alkali metal, more specifically fatty acid salts comprising between about 8 and about 24 carbon atoms comprising sodium, calcium and/or magnesium, in particular calcium salts of one or more fatty acids selected from calcium caprylate, calcium caprate, calcium laurate, calcium myristate, calcium palmitate, calcium stearate.
29. The writing instrument according to any preceding aspect, wherein the lead comprises, relative to the total weight of the lead, between about 0.5 and about 15 wt.-%, more specifically between about 1 and about 7.0 wt.-%, and in particular between about 1.4 and about 5.0 wt.-%, of one or more fatty acid salts comprising a transition metal, more specifically fatty acid salts comprising between about 8 and about 24 carbon atoms comprising a transition metal, in particular zinc salts of one or more fatty acids selected from zinc caprylate, zinc caprate, zinc laurate, zinc myristate, zinc palmitate, zinc stearate.
30. The writing instrument according to any preceding aspect, wherein the lead comprises, relative to the total weight of the lead, between about 0.5 and about 15 wt.-%, more specifically between about 1 and about 10 wt.-%, and in particular between about 2 and about 8 wt.-%, of one or more plasticizers.
31. The writing instrument according to aspect 30, wherein the one or more plasticizers comprises a plasticizer selected from phthalate-based plasticizers, adipate-based plasticizers, benzoate-based plasticizers, sebacate-based plasticizers, and citrate-based plasticizers; and in particular a benzoate-based plasticizer.
32. The writing instrument according to any preceding aspect, wherein the lead exhibits a hexagonal, round or triangular cross section.
33. The writing instrument according to any preceding aspect, wherein the lead is extrudable, extruded or preparable by extrusion.
34. The writing instrument according to any preceding aspect, wherein the lead is not calcinable, not calcined or not preparable by calcination.
35. The writing instrument according to any preceding aspect, wherein the lead comprises less than about 10 wt.-%, more specifically less than about 5 wt.-% and in particular no or substantially no polyolefins or copolymers comprising olefine-based monomer units.
36. The writing instrument according to any preceding aspect, wherein the lead comprises less than about 10 wt.-%, more specifically less than about 5 wt.-% and in particular no or substantially no polystyrene or copolymers comprising styrene-based monomer units.
37. The writing instrument according to any preceding aspect, wherein the lead comprises less than about 10 wt.-%, more specifically less than about 5 wt.-% and in particular no or substantially no hydroxyalkyl cellulose and alkyl cellulose; and in particular no hydroxypropyl cellulose.
38. The writing instrument according to any preceding aspect, wherein the lead comprises less than about 10 wt.-%, more specifically less than about 5 wt.-% and in particular no or substantially no lactic acid-based polymer, in particular polylactic acid.
39. The writing instrument according to any preceding aspect, wherein the lead has a diameter of between about 2 and 4.2 mm, more specifically between about 2 and about 2.3 mm, or between about 3 and about 3.8 mm or between about 3.4 and about 3.8 mm.
40. The writing instrument according to any preceding aspect, wherein the writing instrument further comprises a casing enclosing the lead.
41. The writing instrument according to aspect 40, wherein the casing comprises wood or wood substitute, in particular wherein the wood substitute can comprise polyolefins or copolymers comprising olefine-based monomer units, polystyrene or copolymers comprising styrene-based monomer units, lactic acid-based polymer, in particular polylactic acid and mixtures thereof.
42. The writing instrument according to aspect 40 or 41, wherein the casing is co-extrudable or co-extruded with the lead.
43. The writing instrument according to any one of aspects 40 to 42, wherein the writing instrument further comprises an intermediate layer between the lead and the casing, wherein the intermediate layer is configured to increase the adhesion between the lead and the casing.
44. The writing instrument according to aspect 43, wherein the intermediate layer comprises ethylene butylene acrylate or a mixture of ethylene butylene acrylate and cellulose or ethylene vinyl acetate or a mixture of ethylene vinyl acetate and cellulose.
45. The writing instrument according to aspects 43 or 44, wherein the casing may be co-extrudable or co-extruded with the lead and the intermediate layer.
46. Method of preparing a writing instrument comprising a lead comprising a binder, a filler and a coloring agent, wherein the binder comprises a cellulose ester, wherein said cellulose ester comprises one or more acetate moieties and one or more further ester moieties selected from Cs-carboxylates, more specifically from propionate moieties, the method comprising combining the binder, the filler and the coloring agent.
47. The method according to aspect 46, wherein the lead may be prepared by extrusion.
48. Lead for a writing instrument comprising a lead comprising a binder, a filler and a coloring agent, wherein the binder comprises a cellulose ester, wherein said cellulose ester comprises one or more acetate moieties and one or more ester moieties selected from C₃-carboxylates, more specifically from propionate moieties.
49. Use of a binder comprising a cellulose ester, wherein said cellulose ester comprises one or more acetate moieties and one or more ester moieties selected from C₃-carboxylates for a lead of a writing instrument to improve the intensity of the color deposit and/or to improve the resistance to breakage of the lead.
50. The use according to aspect 49, wherein the cellulose ester comprises one or more ester moieties selected from saturated C₃-carboxylates, in particular moieties selected from propionate, more specifically n-propionate, iso-propionate, or mixtures thereof.
51. The use according to aspect 49 or 50, wherein the cellulose ester comprises cellulose acetate propionate.

1. A writing instrument comprising a lead comprising a binder, a filler and a coloring agent, wherein the binder comprises a cellulose ester, wherein said cellulose ester comprises one or more acetate moieties and one or more ester moieties selected from C₃-carboxylates, more specifically from propionate moieties.

2-17. (canceled)

18. The writing instrument according to claim 1, wherein the cellulose ester comprises one or more ester moieties selected from saturated C₃-carboxylates.

19. The writing instrument according to claim 1, wherein the cellulose ester comprises one or more ester moieties selected from propionate moieties.

20. The writing instrument according to claim 1, wherein the cellulose ester comprises one or more ester moieties selected from n-propionate, iso-propionate, or mixtures thereof.

21. The writing instrument according to claim 1, wherein the cellulose ester comprises cellulose acetate propionate.

22. The writing instrument according to claim 21, wherein the cellulose ester comprises the acetate moieties and the one or more further ester moieties in a molar ratio of from about 10:1 to about 1:10.

23. The writing instrument according to claim 21, wherein the cellulose ester comprises the acetate moieties and the one or more further ester moieties in a molar ratio of from about 1:1 to about 1:4.

24. The writing instrument according to claim 1, wherein the cellulose ester further comprises cellulose acetate butyrate.

25. The writing instrument according to claim 1, wherein the cellulose ester comprises a number-average molecular weight of between about 15.000 g/mol to about 500.000 g/mol.

26. The writing instrument according to claim 1, wherein the lead comprises the binder in amounts of between about 5 and about 70 wt.-% relative to the total weight of the lead.

27. The writing instrument according to claim 1, wherein the filler comprises an inorganic filler.

28. The writing instrument according to claim 1, wherein the filler comprises clay, talc, boron nitride, silica, calcium carbonate, mica, steatite powder and mixtures thereof.

29. The writing instrument according to claim 1, wherein the filler exhibits a lamellar structure.

30. The writing instrument according to claim 1, wherein the filler is colorless, white, or has a CIELAB L* value of greater than about 70, measured according to ISO R457.

31. The writing instrument according to claim 1, wherein the filler comprises particles having a particle size D50 of between 1 and 5 μm.

32. The writing instrument according to claim 1, wherein the coloring agent comprises one or more pigments, one or more dyes, or mixtures thereof.

33. The writing instrument according to claim 1, wherein the lead further comprises one or more additives, selected from the group consisting of slip agents, processing agents, coupling agents, dispersants, lubricants, plasticizers, preservatives and mixtures thereof.

34. The writing instrument according to claim 1, wherein the lead is not calcinable, not calcined or not preparable by calcination.

35. Method of preparing a writing instrument comprising a lead comprising a binder, a filler and a coloring agent, wherein the binder comprises a cellulose ester, wherein said cellulose ester comprises one or more acetate moieties and one or more further ester moieties selected from C3-carboxylates, the method comprising combining the binder, the filler and the coloring agent.

36. Use of a binder comprising a cellulose ester, wherein said cellulose ester comprises one or more acetate moieties and one or more ester moieties selected from C3-carboxylates for a lead of a writing instrument to improve the intensity of the color deposit.
